(19) United States
(12) Patent Application Publication
(10) Pub. No.: US 2012/0269469 A1
(43) Pub. Date: Oct. 25, 2012

(54) RECLOSABLE FULL OPEN MOUTH BAG WITH A HOOK AND HOOK CLOSURE AND ASSOCIATED METHODS

(75) Inventors: David Brian Long, Spartanburg, SC (US); Melania Craddock, Spartanburg, SC (US)

(73) Assignee: EXOPACK LLC, Spartanburg, SC (US)

(21) Appl. No.: 13/320,064

(22) PCT Filed: Oct. 4, 2011
(86) PCT No.: PCT/US11/54778

§ 371 Date: Nov. 11, 2011

Related U.S. Application Data
(60) Provisional application No. 61/389,558, filed on Oct. 4, 2010.

(51) Int. Cl. B65D 33/16; B31B 1/64; B65D 30/10; B31B 1/90

(52) U.S. Cl. 383/210.1; 383/95; 493/214; 493/189; 383/94

(57) ABSTRACT

A reclosable bag with a hook and hook closure can include walls formed of a material having multiple layers, which can include at least one gusset. The bag can be formed into a full open mouth configuration for ease of filling and ease of dispensing product. The hook and hook closure allows for an imprecise alignment of the closure track to substantially close the bag around the gusset area. A method of manufacturing a reclosable bag with a hook and hook closure is also presented.

### TECHNICAL FIELD

Embodiments disclosed herein relate generally to a reclosable full open mouth bag with a hook and hook closure that can be used in the packaging industry, and more particularly to the pet food industry, and methods for manufacturing the same.

### BRIEF DESCRIPTION OF THE DRAWINGS

The written disclosure herein describes illustrative embodiments that are non-limiting and non-exhaustive. Reference is made to certain of such illustrative embodiments that are depicted in the figures as listed below.

FIG. 1 illustrates a perspective view of an embodiment of a reclosable bag having a closed end and an open end with a hook and hook closure.

FIG. 2 illustrates a perspective view of an embodiment of a reclosable bag containing product, compatible with the bag of FIG. 1.

FIG. 3 illustrates a perspective view of another embodiment of a reclosable bag containing product, compatible with the bag of FIG. 1.

FIG. 4 illustrates a partial exploded view of an embodiment of the hook and hook closure of a reclosable bag, compatible with the bag of FIG. 1.

FIG. 5 illustrates a partial cross-sectional view of an embodiment of the hook and hook closure that is being closed or engaged.

FIG. 6 illustrates a partial exploded view of another embodiment of the hook and hook closure of a reclosable bag, compatible with the bag of FIG. 1.

FIG. 7 illustrates a partial cross-sectional view of another embodiment of the hook and hook closure that is being closed or engaged.

FIG. 8 illustrates a partial cross-sectional view of another embodiment of the hook and hook closure that is being opened or disengaged.

FIG. 9 illustrates a perspective view of a further embodiment of a reclosable bag, compatible with the bag of FIG. 1.

FIG. 10 illustrates a perspective view of a further embodiment of a reclosable bag, compatible with the bag of FIG. 1.

FIG. 11 illustrates a perspective view of a further embodiment of a reclosable bag, compatible with the bag of FIG. 1.

FIG. 12 illustrates a partial exploded view along the axis 12 of FIG. 11, of a further embodiment of a reclosable bag, compatible with the bag of FIG. 1.

FIG. 13 illustrates a perspective view of an embodiment of an open reclosable bag, compatible with the bag of FIG. 1.

FIG. 14 illustrates a perspective view of an embodiment of a reclosable bag, compatible with the bag of FIG. 1, after reclosing.

FIG. 15 illustrates a perspective view of sealing the top end of a reclosable bag, compatible with the bag of FIG. 1.

FIG. 16 illustrates a perspective view of an embodiment of a reclosable bag, compatible with the bag of FIG. 1, with a seal on the top end in addition to the hook and hook closure.

FIG. 17 illustrates a partial exploded view along the axis 17 of FIG. 16, of a further embodiment of a reclosable bag, compatible with the bag of FIG. 1.

FIG. 18 illustrates a perspective view of a further embodiment of a reclosable bag, compatible with the bag of FIG. 1, with a seal on the top end in addition to the hook and hook closure.

### DETAILED DESCRIPTION

Embodiments of a bag with a reclosable seal are disclosed. In certain embodiments, the bag is formed into a full open mouth configuration, also known as a quad seal bag, which can be filled at high speeds. This configuration of bag may be useful as it is easy to fill with product and similarly, easy to dispense product from. The bag may be formed from single or multiple layers of paper and/or a polymeric material, or mixtures thereof. Each layer can provide the bag with one or more desirable characteristics, depending on the application of the bag. The bag may have a reclosable hook and hook closure. Such embodiments, as well as others, are herein disclosed in detail.

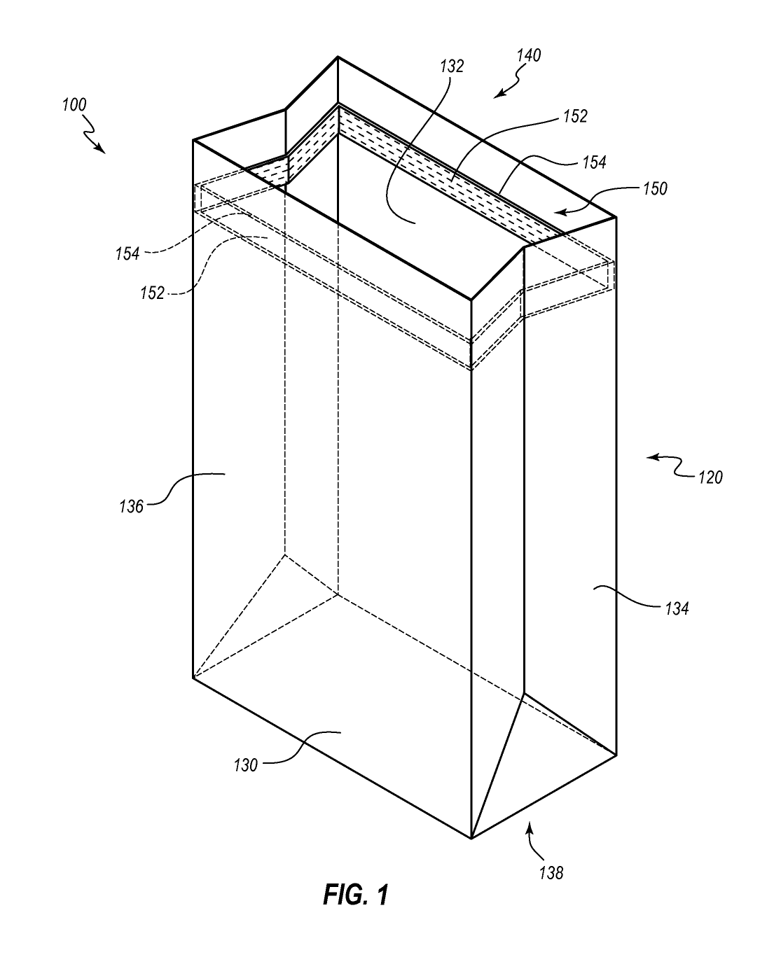

FIG. 1 illustrates a perspective view of an embodiment of a reclosable bag 100. The bag 100 can include a body portion 120, which can be substantially tubular in form. For example, in some embodiments, the body portion 120 defines a front wall 130, a back wall 132, a first side wall 134, and a second side wall 136. In certain embodiments, the bag 100 defines a full open mouth configuration, and can include a closed bottom end 138 of the body portion 120. When the bag 100 is in a full open mouth configuration, a top end 140 of the bag 100 can be open such that a product can be received into the bag 100, and the product can be maintained within the bag 100 via the closed bottom end 138.

In some embodiments, the body portion 120 comprises a sheet of material that is folded or otherwise formed into the substantially tubular structure. The material can comprise multiple layers, each of which can provide or aid in providing desirable functional characteristics to the bag 100. In certain embodiments, the first and second sidewalls may be gusseted, to allow for expansion and/or reinforcement. For example, the sidewalls may each contain a single gusset. Alternatively, the sidewalls may contain multiple gussets.

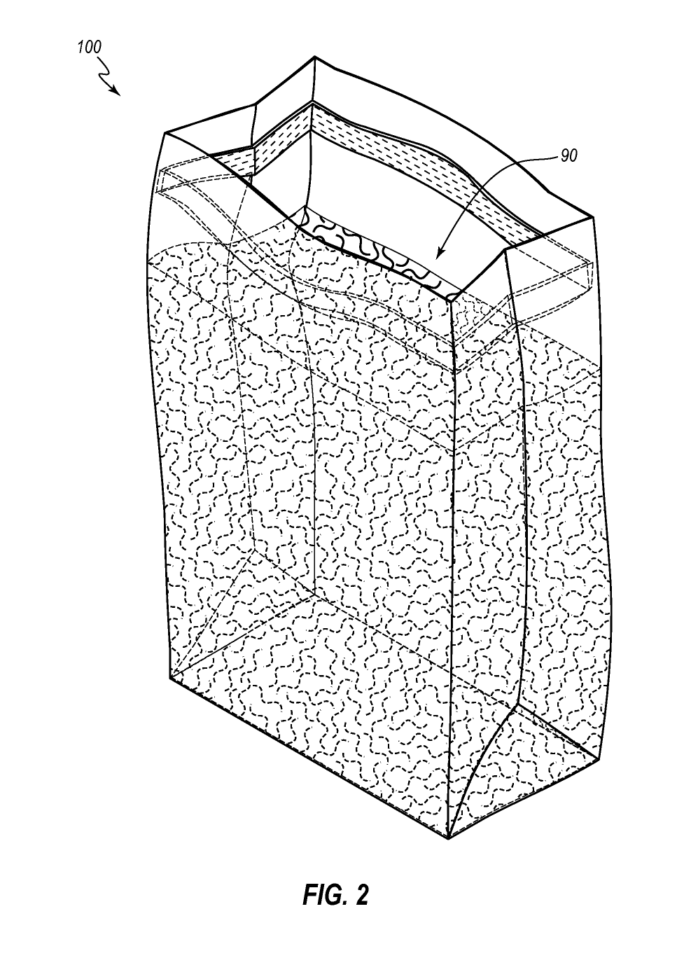

With reference to FIG. 2, in certain embodiments, the bag 100 can have contents disposed therein, such as a product 90. Once the product 90 is within the bag 100, the top end 140 of the bag 100 can be closed in any suitable fashion. For example, the illustrated embodiment includes a closed bottom end 138 of the bag 100 (discussed above).

In other embodiments, a heat-seal and/or an adhesion seam can be used to close the top end 140 of the bag 100. For example, various embodiments of the bag 100 can have a self-opening sack bottom at the bottom end 138, and the other end can be closed in any suitable manner. Accordingly, for certain portions of the following discussion, it can be assumed that the bottom end 138 of the bag has been previously sealed, and the top end 140 of the bag is subsequently sealed.

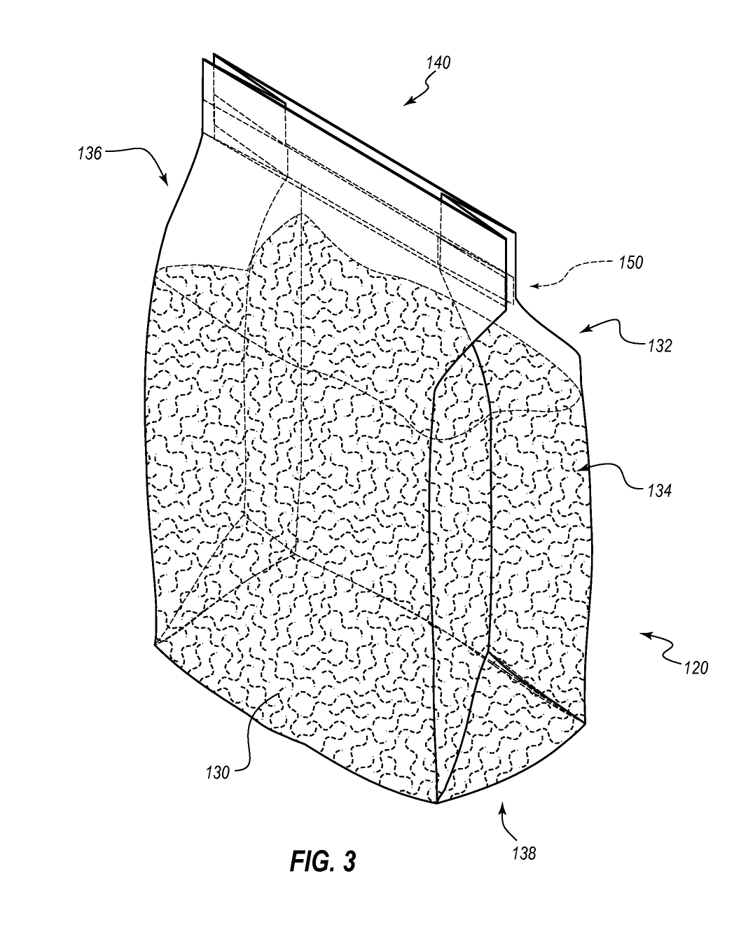

As illustrated in FIGS. 1-3, in certain embodiments, a bag 100 can be formed with sidewalls 134, 136 which may be gusseted. In some embodiments, the sidewalls 134, 136 of the tube body 120 can be urged inward to form the gussets, and can be creased or folded. With reference to FIG. 3, in some embodiments, the hook and hook closure 150 extends around the circumference of the tube body 120, including the gusseted side walls (e.g., the side walls 134, 136). The hook and hook closure 150 can circle the first, second, third, and fourth walls 130, 132, 134, 136 in a substantially fixed state. When re-closed by the user, as in FIG. 3, the hook and hook closure 150 can hold the front, side and back walls in close engagement with one another so as to form a substantially closed seal.

Alternatively, the hook and hook closure 150 may circle a subset of the walls 130, 132, 134 136. In further embodiment, the hook and hook closure 150 may be applied in a discontinuous fashion such as only within the gusseted regions 134, 136, or in alternating patches around the front, side and back walls 130, 132, 134, 136 to provide a closure without requiring a full circumference. This may be useful for cost reasons, for example.

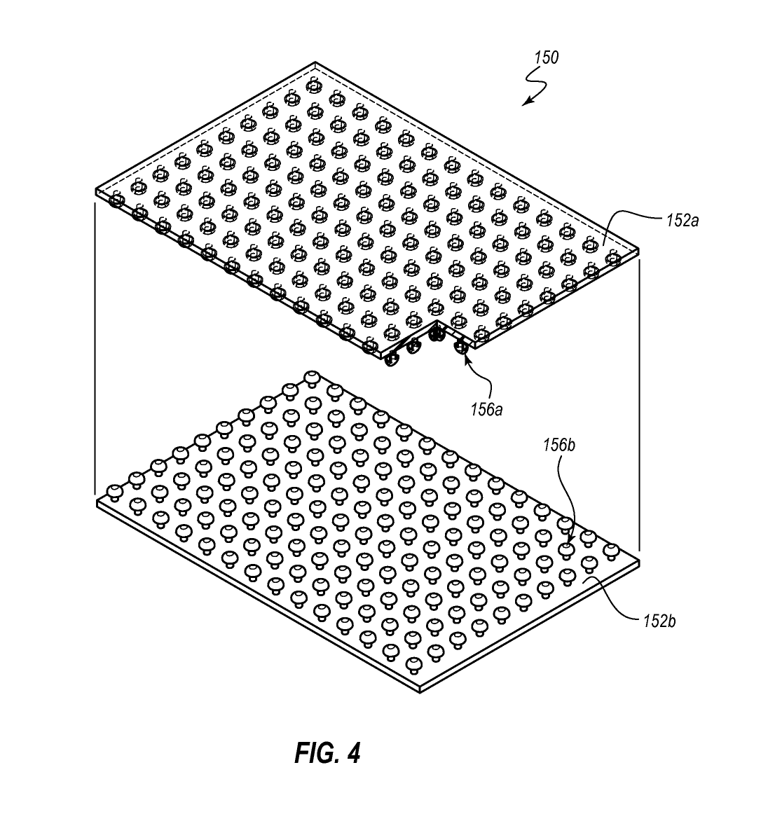

With reference to FIGS. 1 and 4, in other embodiments, the top end 140 of the bag can comprise a hook and hook closure 150. In certain embodiments, the hook and hook closure 150 can be reclosable such that the closure can be selectively opened or closed repeatedly, as desired, without the need for perfect alignment of the hook and hook track 152. The hook and hook closure 150 can be formed of T-shaped or mushroom-shaped appendages 156a, 156b. In some embodiments, the hook and hook closure 150 comprises one or more connection portion 154, which can comprise a skirt, flaps, or extensions. The connection portion 154 can be connected to the top end 140 of the tube body 120 in any suitable manner, and in some embodiments, can form a substantially closed seal therewith, as further discussed below.

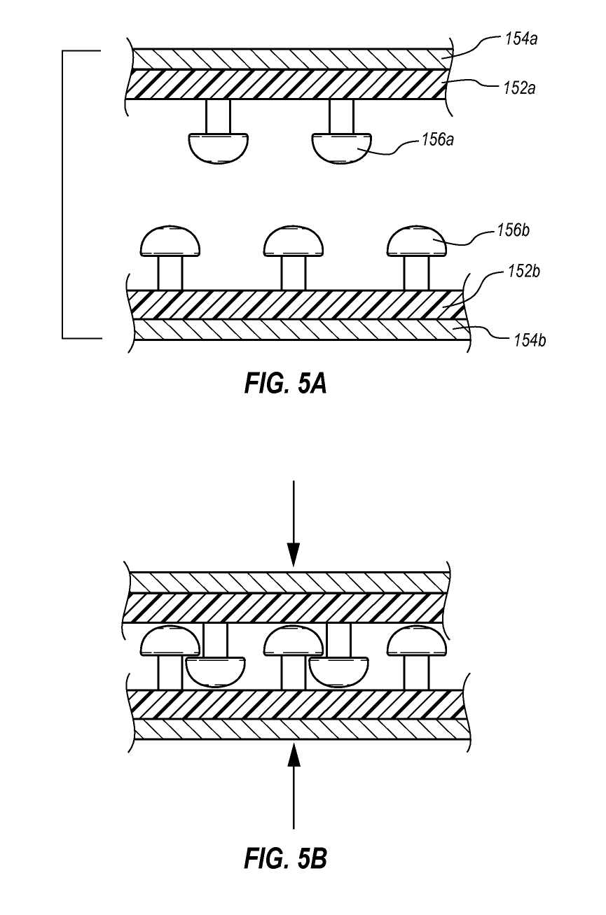

With reference to FIGS. 4 and 5, the hook and hook closure 150 comprises a hook and hook track 152a that is opposite from another hook and hook track 152b. Tracks 152a, 152b are configured to engage each other and disengage from each other. In some embodiments, hook and hook tracks 152a, 152b can form a substantially closed seal when engaged with each other. A user can compress any portion of the hook and hook tracks 152a, 152b into sealed contact with each other to transition the hook and hook closure 150 to the engaged, or closed, state (FIGS. 5A -5B). Aligning a portion of track 152a containing hook 156a, with a portion of track 152b containing hook 156b, and pressing the tracks 152a, 152b together with sufficient force (FIG. 5B), a user can close the closure.

Because of the multiple hooks 156a, 156b in each respective track 152a, 152b, perfect alignment of the tracks 152a, 152b is not necessary to obtain a substantially closed seal. The user can manually pull the hook and hook tracks 152a, 152b apart to cause the hook and hook closure 150 to separate from each other to transition the hook and hook closure 150 from the engaged, or closed, state (FIG. 5B) to the disengaged, or open, state (FIG. 5A). As the hooks 156a, 156b are not damaged by engaging or disengaging, multiple engagements and disengagements are possible.

The hooks 156a, 156b are able to close and open repeatedly in the presence of any fine particles that may be present in the product 90. Further, the ability of the hook and hook tracks 152a, 152b to seal the side walls 134, 136 without requiring perfect alignment of the tracks is particularly useful, unlike conventional closures comprising, for example, a press-to-seal or zipper track and block system.

The tracks 152a, 152b may be of various widths, depending upon the weight and nature of the product 90. For example, a larger bag containing a heavy product may require a stronger hook and hook closure than a smaller bag with lightweight product. The surface area of the hook and hook closure 150 may be increased in order to increase its strength, such that inadvertent opening of the closure is difficult under the load from product 90. For example, a wide track 152a, 152b may be needed for larger bags and a narrow track for smaller bags. Alternatively, the strength of the material used for the hooks used in the closure 150 may increase, to also increase the strength of the closure. This may be accomplished, for example, by using a more rigid polymer for the hooks of the closure 150.

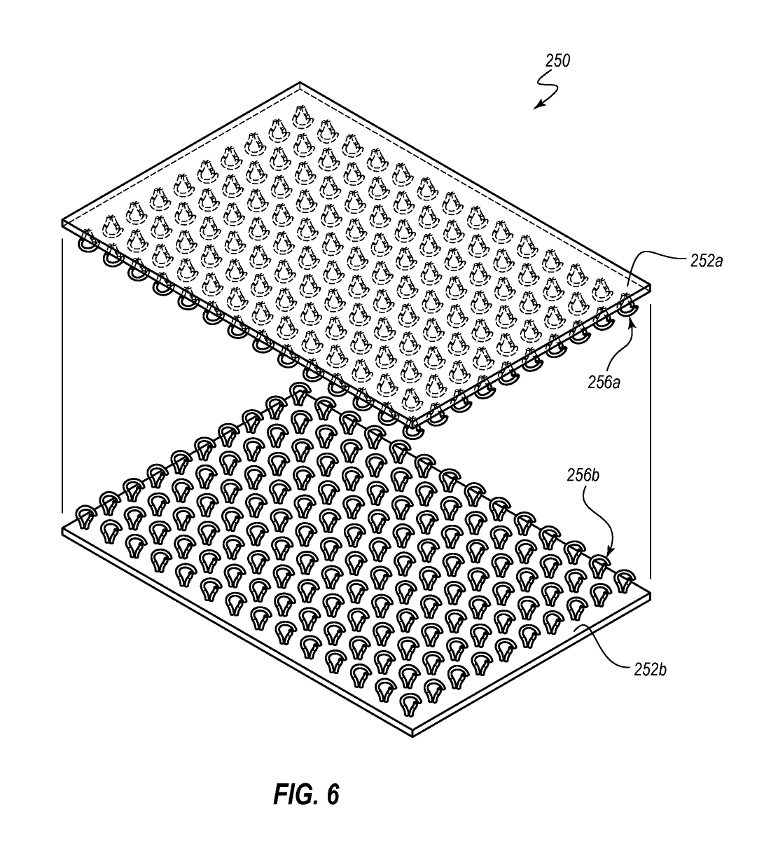

With reference to FIGS. 1 and 6-8, in other embodiments, the top end 140 of the bag can comprise a hook and hook closure 250. The hook and hook closure 250 can be formed of hook-shaped appendages 256a, 256b. In some embodiments, the hook and hook closure 250 comprises one or more connection portions 254, which can comprise a skirt, flaps, or extensions. The connection portion 254 can be connected to the top end 140 of the tube body 120 in any suitable manner, and in some embodiments, can form a substantially closed seal therewith, as further discussed below. Alternatively, the connection portion 254 may be connected to the tube body 120 in a position between the top end 140 and the closed bottom end 138.

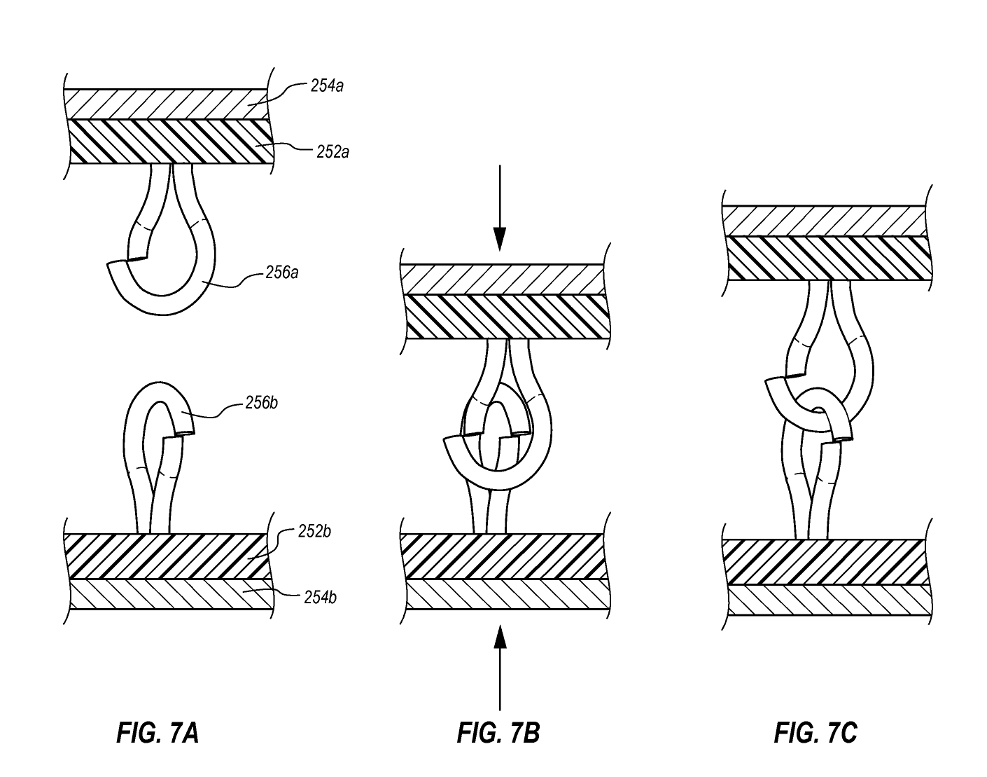

The hook and hook closure 250 comprises a hook and hook track 252a that is opposite from another hook and hook track 252b. Tracks 252a, 252b are configured to engage each other and disengage from each other. In some embodiments, hook and hook tracks 252a, 252b can form a substantially closed seal when engaged with each other. A user can compress any portion of the hook and hook tracks 252a, 252b into sealed contact with each other to transition the hook and hook closure 250 to the engaged, or closed, state (FIGS. 7A-7C). Aligning a portion of track 252a containing hook 256a, with a portion of track 252b containing hook 256b, and pressing the tracks 252a, 252b together with sufficient force (FIG. 7B), a user can close the closure (FIG. 7C). Because of the multiple hooks 256a, 256b in each respective track 252a, 252b, perfect alignment of the tracks 252a, 252b is not necessary to obtain a substantially closed seal.

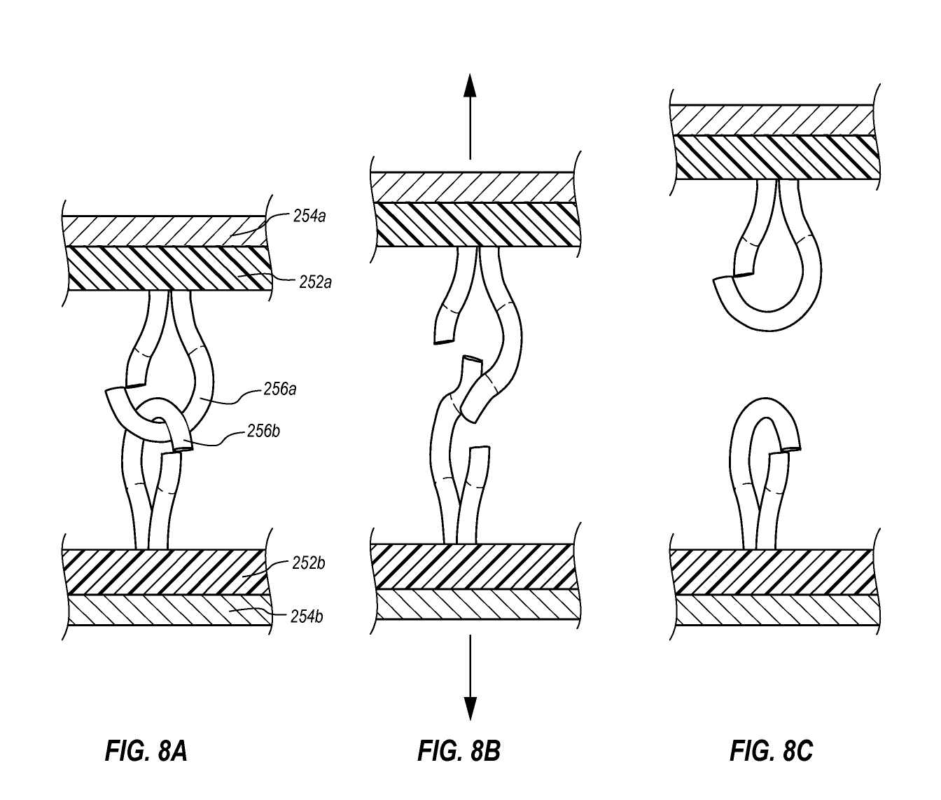

With reference to FIGS. 8A-8C, the user can manually pull the hook and hook tracks 252a, 252b apart to cause the hook and hook closure 250 to separate from each other to transition the hook and hook closure 250 from the engaged, or closed, state (FIG. 8A) to the disengaged, or open, state (FIG. 8B). Pulling apart tracks 252a, 252b with sufficient force to cause hooks 256a, 256b to no longer interact (FIG. 8B), will open or disengage the hook and hook closure 250. As the hooks 256a, 256b are not damaged by engaging or disengaging, multiple engagements and disengagements are possible.

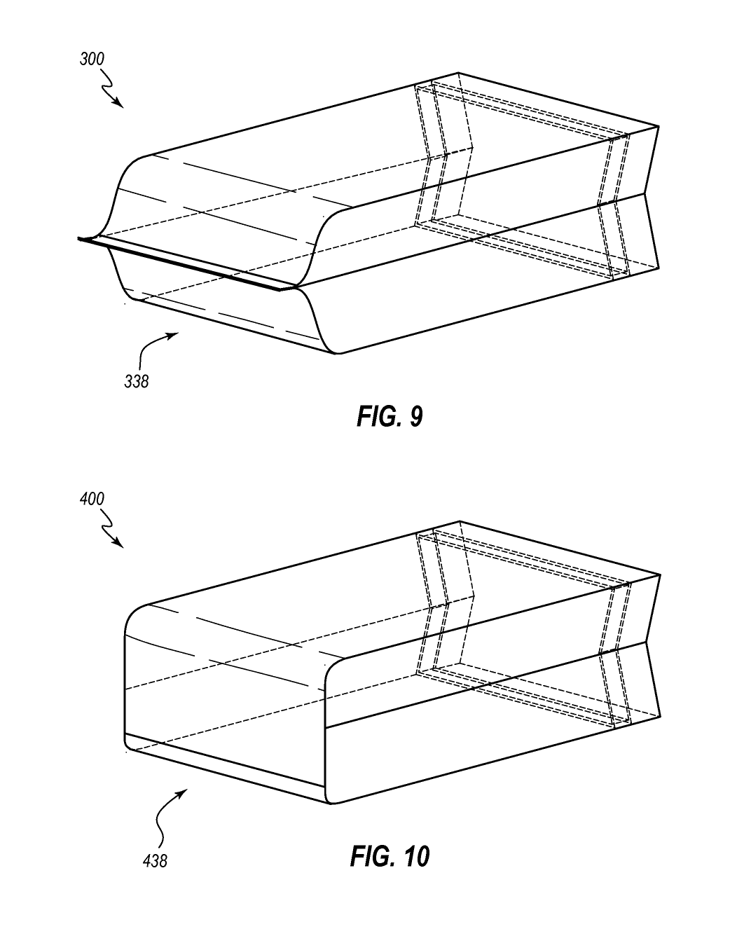

With reference to FIGS. 9-10, in further embodiments, the bag 100 may have a heat seal applied at the bottom end of the bag 138, to close the bottom end of the bag. For example, a bag 300 (FIG. 9) may have a bottom seal 338. Alternatively, a bag 400 (FIG. 10) may have a bottom seal 438 that is folded face to back and a hot melt applied, to provide a pinched end for improved bottom display purposes.

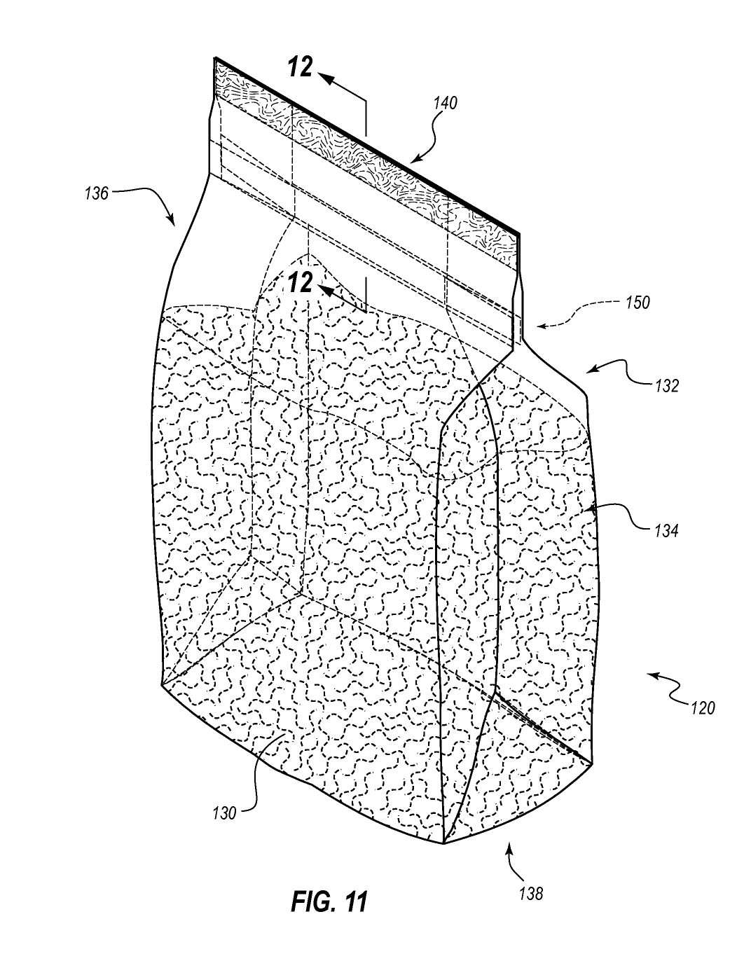

With reference to FIGS. 5 and 11, in some embodiments, the connection portion 154 of the hook and hook closure 150 comprises a heat sealable material. In some embodiments, the connection portion 154 is placed in contact with an inner surface of a heat sealable portion of an inner ply of body portion 120 and is heat sealed thereto. Any suitable heat sealing methods and materials may be used, such as those discussed herein.

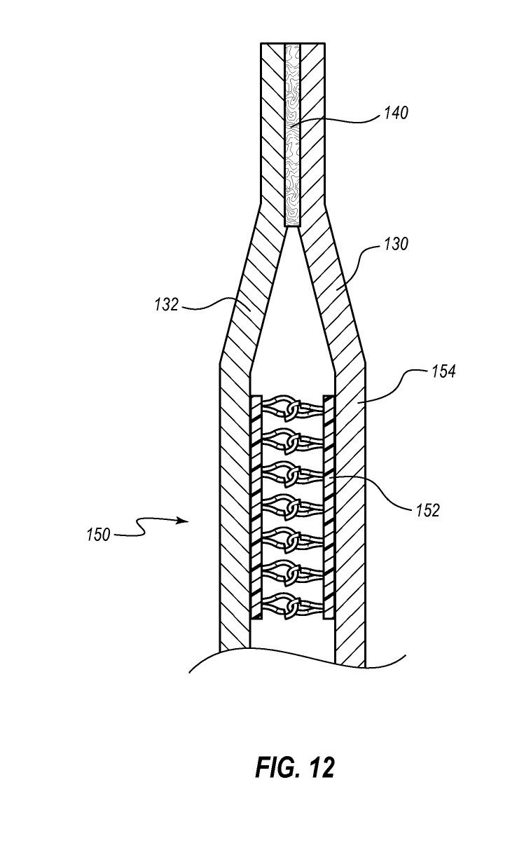

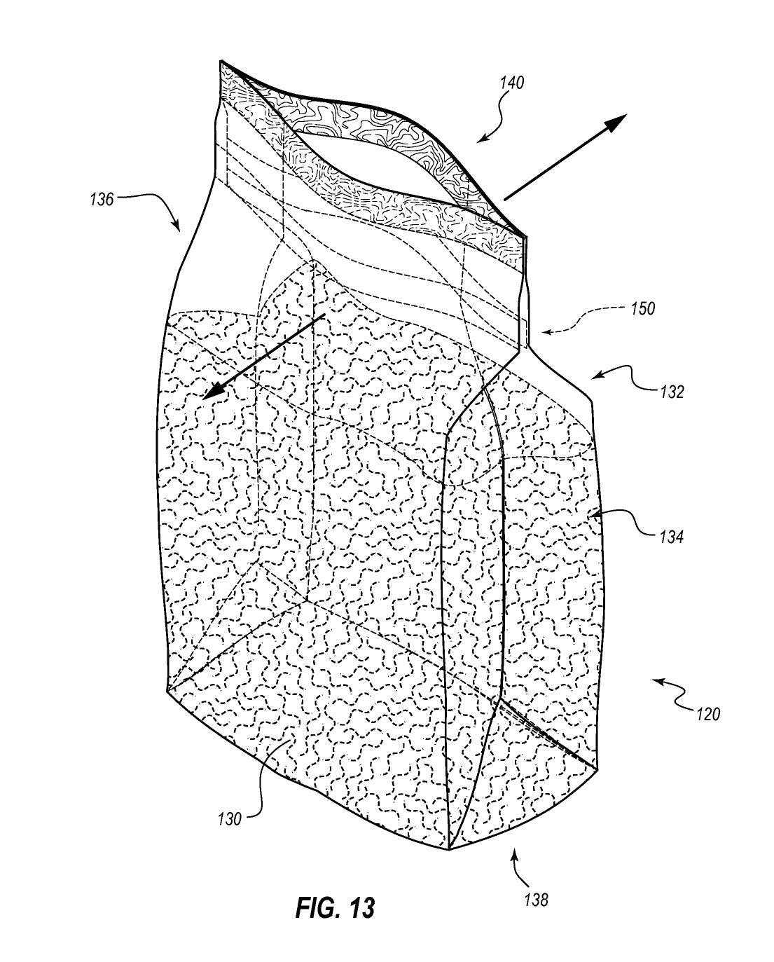

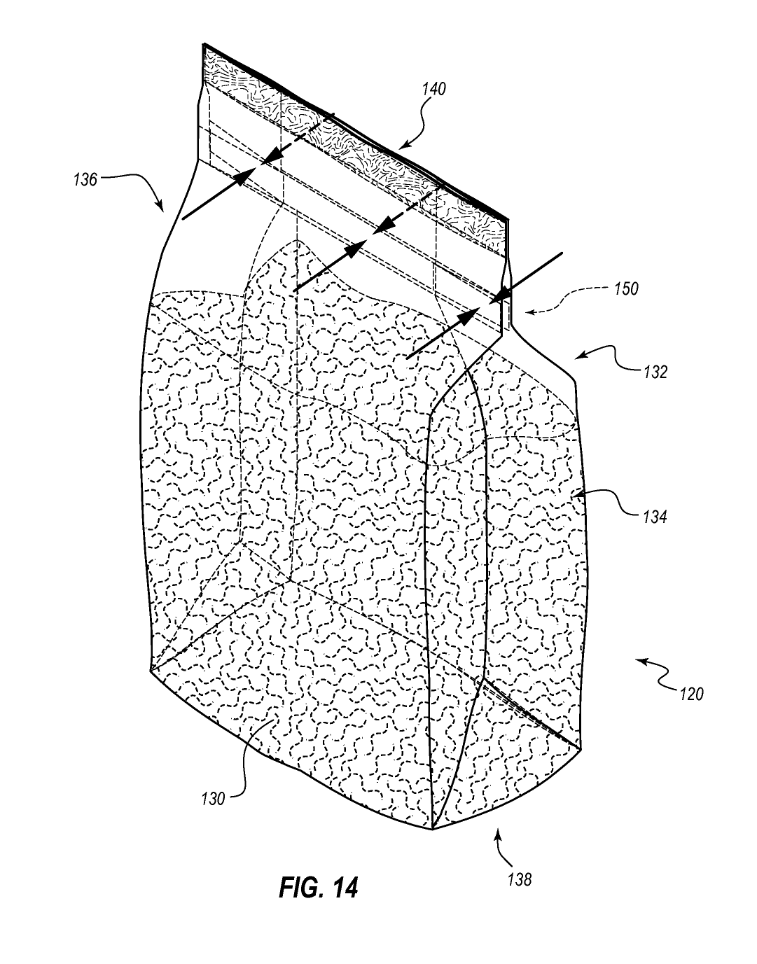

With reference to FIGS. 11-14, looking along the axis defined along sight line 12 in FIG. 11, the top end 140 may be sealed without affecting the connection portion 154 and track 152 of the hook and hook closure 150. In an embodiment, there is a space along the axis between the top end 140 and the hook and hook closure track 152 to allow for a user to grasp the front and back walls 130, 132 and open or close the bag if the top end 140 and seal has been removed. Alternatively, there may be space between the hook and hook closure 150 and the bag bottom end 138 for this purpose.

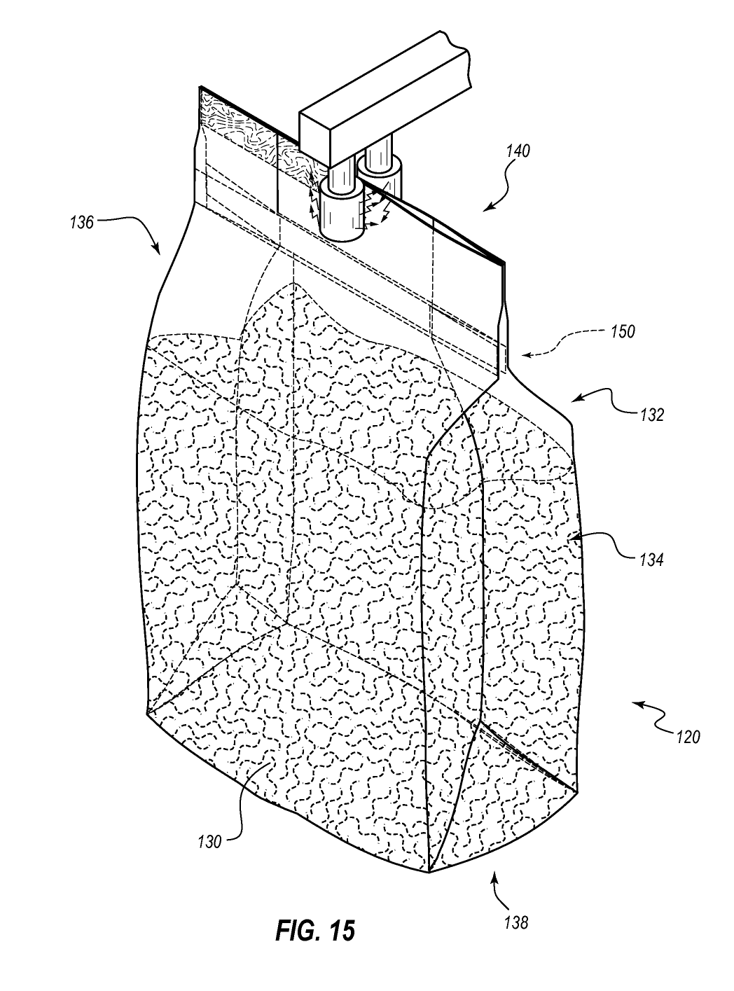

With reference to FIG. 15, in an embodiment, the top end 140 may be heat sealed without affecting the hook and hook closure 150. For example, the top end 140 may be heat sealed in a non-reclosable manner for transport, leaving the hook and hook closure 150 available for re-closing. Sealing the top end 140 may be useful to provide a moisture or oxygen resistant barrier to reduce degradation of the product 90. In an embodiment, the sealing of the top end 140 may include a score line or weakened portion of the seal to aid in opening the top end.

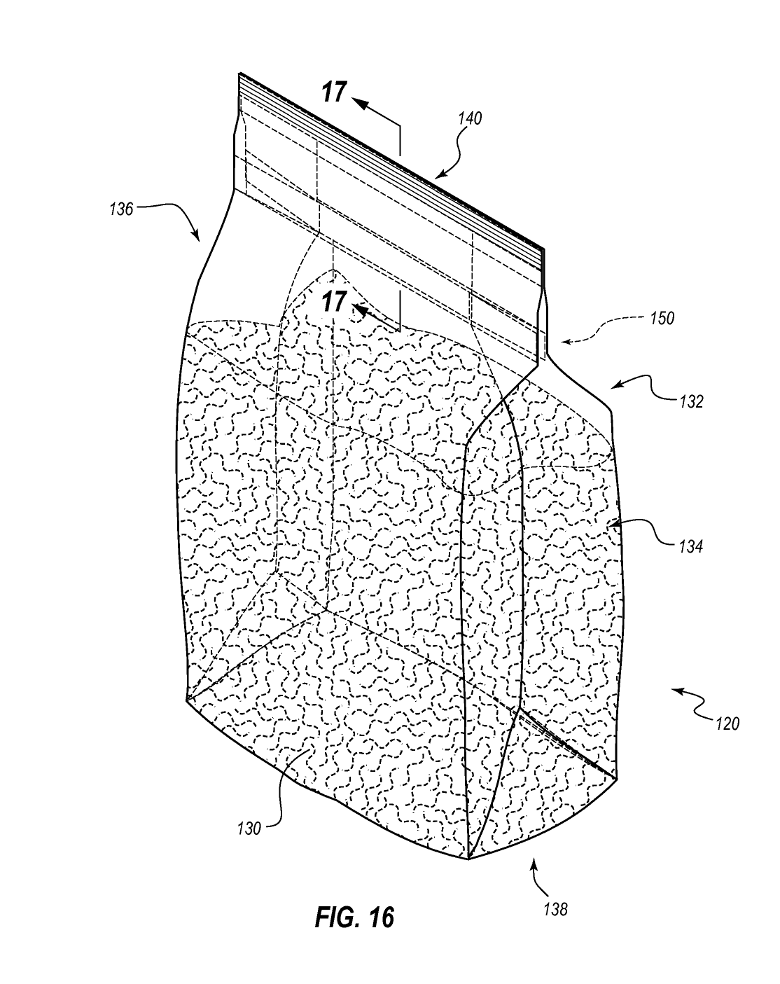

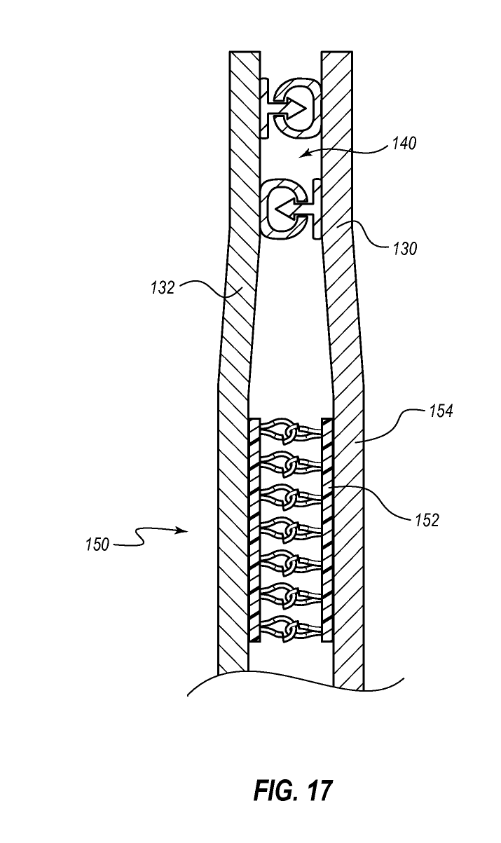

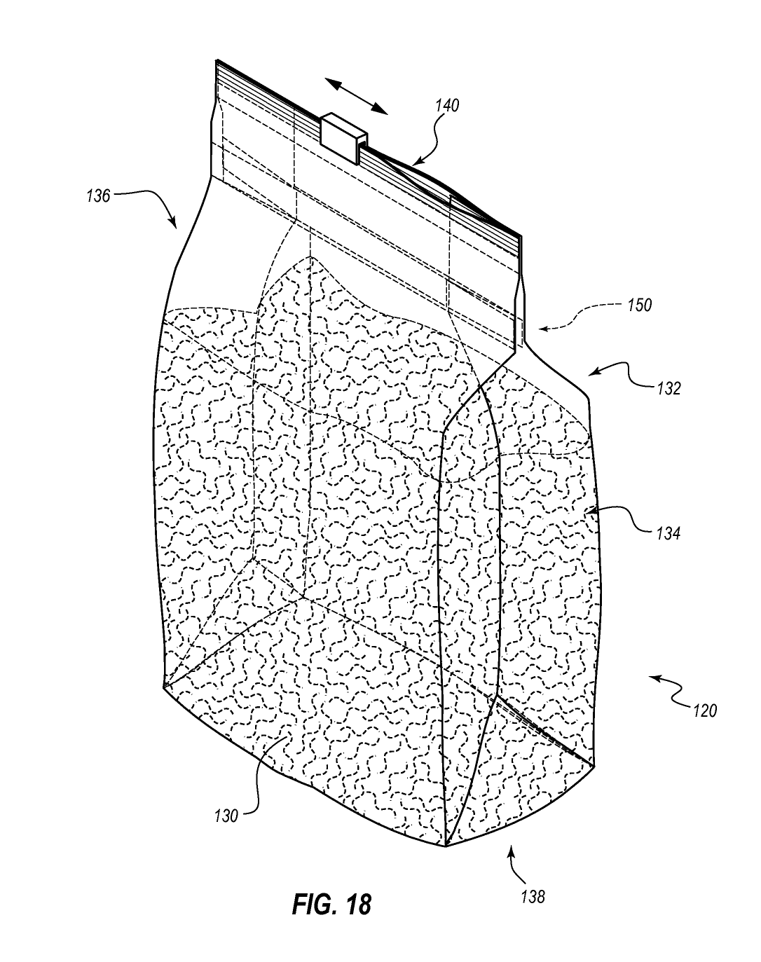

With reference to FIGS. 16-18, the top end 140 may be sealed in a reclosable manner, for example with a press-to-close seal (FIGS. 16-17) or a zipper block and track system (FIG. 18). In an embodiment, the press-to-close seal has two sets of interlocking tracks at the top end 140 of the bag, as shown in FIG. 17 looking along the axis defined along sight line 17 in FIG. 16. Alternatively, the seal may have only one set of interlocking tracks. the top end 140 may be sealed without affecting the connection portion 154 and track 152 of the hook and hook closure 150. In an embodiment, there is a space along the axis between the top end 140 and the hook and hook closure track 152 to allow for a user to grasp the front and back walls 130, 132 and open or close the bag if the top end 140 and seal has been removed. Alternatively, there may be space between the hook and hook closure 150 and the bag bottom end 138 for this purpose. Any reclosable or non-reclosable closure known to a person skilled in the art may also be used to seal the top end 140, if desired, in addition to the hook and hook closure 150.

In some embodiments, the bag 100 can substantially block or serve as a barrier to elements such as, for example, grease, moisture, liquids or odors.

In certain embodiments, the material of which the body portion 120 of the bag is formed can comprise an outer ply and an inner ply. In some embodiments, an inner face (e.g., an inwardly facing surface) of the outer ply is adhered to an outer face (e.g., an outwardly facing surface) of the inner ply. In further embodiments, the inner and outer plies can be in abutting contact. For example, the inner ply can be laminated to the outer ply. In certain embodiments, the outer ply can comprise a film and a paper layer. The film and the paper layer can be joined in any suitable fashion. For example, the film and the paper layer can be laminated, such as via adhesive lamination or extrusion lamination. The film can be adhered (e.g., in abutting contact) to an outer face of the paper layer via a tie layer. In various embodiments, the tie layer can comprise a solvent-based or solventless adhesive, a plastic-type bonding material, or a co-extruded film. In some embodiments, the tie layer comprises polyurethane.

In certain embodiments, the film comprises a polyolefin, and may comprise a thermoplastic material. For example, in various embodiments, the film comprises polyethylene terephthalate (PET), polyethylene terephthalate polyester (PETP), polytrimethylene terephthalate (PTT), polybutylene terephthalate (PBT), polypropylene (PP), or nylon (PA). PP films may be oriented or non-oriented, and may be woven. Certain films, such as some embodiments that comprise polyester (e.g., PETP), can be puncture-resistant, tear-resistant, scratch-resistant, grease-resistant, and/or absorption-resistant. These properties can aid in providing a bag with, and in maintaining, an aesthetically pleasing appearance.

In some embodiments, the film can include one or more materials configured to provide or enhance the moisture-resistance or other barrier properties of the film. For example, in some embodiments, the film can be resistant to or substantially impermeable to mineral oils, solvents, and acids. The film can include, for example, plastics, polyvinyl chloride (PVC), polyamide (PA), polyethylene (PE), polystyrene (PS), and/or polypropylene (PP).

In some embodiments, the film can range from about 30 gauge to about 300 gauge. In an embodiment, the film can range from about 40 gauge to about 100 gauge. In other embodiments, the thickness can range from about 36 gauge to about 48 gauge. For example, the film can be about 48 gauge, no more than about 100 gauge, or no less than about 20 gauge. Alternatively, the film can be a PET or PP film and range from about 48 gauge to about 92 gauge. In further embodiments, the film is a nylon film and range from about 60 gauge to about 100 gauge. The film, however, can have other gauges for pet food bags, or for other applications, as needed or desired.

In certain embodiments, the film can be treated with a coating on the outer face thereof. The coating can protect against abrasion of the film, and may provide an aesthetically appealing gloss finish. In some embodiments, the coating can facilitate adhesion and bonding and can increase a coefficient of friction of the bag. In some embodiments, the coating can include printed indicia, which can be surface printed or reverse printed. In various embodiments, the coating can comprise, for example, a flexography coating, a proprietary coating, or any other suitable coating.

In certain embodiments, an outer face of the film can have a coefficient of friction in a range of from about 0.2 to about 0.9, or from about 0.3 to about 0.8. In an embodiment, the coefficient of friction is no more than about 0.9, or no less than about 0.2. Other ranges and values are also possible. The coefficient of friction, for example, for certain pet food bag applications can be sufficiently large to inhibit slipping or sliding of a bag when positioned on a shelf or cabinet.

In certain embodiments, the film can be amorphous, which is a classification indicating that it is highly transparent and colorless, or can be semi-crystalline, which is a classification indicating that it is translucent or opaque with an off-white coloring, or mixtures of both an amorphous and a semi-crystalline component. In some embodiments, a film can be printed with solvent-based inks or water based inks, and can be printed overall with a flood coat of white ink, which may advantageously allow for high-quality graphics.

In certain embodiments, instead of reverse printing indicia on the inner face of the film, indicia can be surface printed on the outer face of the film. It is also possible to print indicia on both the inner and outer faces of the film. In other embodiments, the film can be unprinted (e.g., the film can be substantially plain and/or clear). The film can provide a bag 100 with a superior appearance, as compared with, for example, standard pet food bags. For example, a printing on the film can be more aesthetically pleasing than similar printing applied to paper bags that do not have an outer film.

In certain embodiments, the paper layer of the outer ply can exhibit a bending stiffness, modulus, and/or tensile stiffness that is larger than that of the film. In further embodiments, the paper layer can be thicker than the film. In some embodiments, the paper layer can provide sufficient structural rigidity to permit the bag 100 to be placed in and remain in an upright position. For example, the bag 100 might contain a product 90 in an amount sufficient to fill only a fraction (e.g., ¼, ⅓) of the bag. In certain of such embodiments, the product 90 can be settled at the bottom end of the bag 100, and the bag 100 can be set upright on its bottom end. Although the product 90 does not generally support the top end 140 of the bag 100 in such a configuration, the bag 100 can nevertheless remain in a substantially upright configuration, and can resist gravitational force acting on the top end 140 of the bag 100 due to the stiffness of the paper layer.

As used herein, the term “stiffness” is a broad term used in its ordinary sense, and can include bending stiffness or tensile stiffness. Other suitable measurements of stiffness can also be utilized, such as droop stiffness, folding endurance, or other alternative measurements. In certain instances, bending stiffness represents the rigidity of paper or paperboard. In some cases, the bending stiffness of an item can be a function of (e.g., can be proportional to) the cube of the caliper thickness of the item. Bending stiffness can also be related to the modulus of elasticity of the item. In many embodiments, the bending stiffness of a paper layer generally increases as the thickness of the paper layer is increased.

Various instruments may be used to measure stiffness, many of which determine the stiffness of an item by subjecting it to bending of one variety or another. For example, some instruments employ TAPPI 2-point bending, while others employ TAPPI 4-point bending. Solid fiber boards and small fluted combined boards (which can be used in folding cartons) are typically measured with TAPPI 2-point bending methods. Suitable instruments for measuring bending stiffness can include Taber, Gurley, and L&W instruments.

In many embodiments, the stiffness of the paper layer is selected such that the multi-layer material of which a bag 100 is ultimately formed can be laminated on existing machinery. Likewise, in many embodiments, the stiffness of the paper layer is selected such that the material can be formed into the bag 100 on existing converting equipment. In some embodiments, the paper layer can define a thickness in a range of between about 1.75 mils and about 10 mils, and in further embodiments, the thickness can be between about 3.0 mils and about 4.0 mils. For example, in some embodiments, the minimum thickness is about 1.9 mils.

In various embodiments, the film can define a thickness in a range of between about 0.25 mils and about 1.25 mils, between about 0.25 mils and about 0.75 mils, or between about 0.70 mils and about 1.25 mils. In some embodiments, the film can be 48 gauge and/or have a thickness in the range of about 0.475 mils to about 0.485 mils. Increased thickness of the paper layer and/or the film can provide for increased bending stiffness and increased stabilization of a bag 100. In some embodiments, the film can comprise PET and can define a thickness within a range of between about 0.25 mils and about 0.75 mils. In other embodiments, the film can comprise PE and can define a thickness within a range of between about 3.0 mils and about 7.0 mils. In further embodiments, the film can comprise BOPP and can define a thickness within a range of between about 0.70 mils and about 1.25 mils.

In certain embodiments, the paper layer can advantageously enhance the durability of a bag 100. Various basis weights of paper can be utilized, for example, ranging from about 30 pound-force/inch to about 50 pound-force/inch, as these units are understood by those skilled in the art. In other embodiments, the paper can be in a range between about 20 pounds per 3,000 square feet and about 80 pounds per 3,000 square feet. Embodiments of the paper layer can be coated (e.g., clay-coated) and/or bleached, or in other embodiments, can be manufactured without coating or bleach. In some embodiments, the paper layer may be 3 plies using a range of from about 30 to about 70 pound paper plies, with films ranging from about 0.7 mil to about 2.0 mil.

In some embodiments, an outer face of the paper layer can include printed indicia. Procedures for printing indicia can include process printing, rotogravure printing, innovative flexographic printing, etc. In some embodiments, the film does not include printed indicia when the paper layer is printed, which can prevent the film from obscuring the printed matter of the paper layer. In other embodiments, both the paper layer and the film can include printed portions.

In various embodiments, the inner ply may be adhered or otherwise joined to the outer ply. In some embodiments, the inner ply comprises multiple layers. In other embodiments, the inner ply comprises a single layer. In either case, the inner ply can be configured to resist or prevent the penetration or absorption of grease, mineral oils, solvents, and acids into or through the walls of a bag 100.

In some embodiments, the inner ply exhibits a high degree of puncture resistance. This property can also be advantageous depending on the type of product 90 stored in a bag 100. For example, in some embodiments, the packed product 90 can be relatively abrasive such that the inner ply is desirably capable of withstanding the formation of pinholes during transportation and/or use of the bag 100.

In some embodiments, the inner ply comprises a high modulus (e.g., modulus of elasticity) such that it is able to elastically stretch. When incorporated into the multi-layered material that forms the body portion of a bag 100, such an inner ply can provide the bag 100 with resiliency, which can help to prevent rips, tears, or punctures.

In certain embodiments, the inner ply can include a single-layer or mono-layer film. In some embodiments, the inner ply can comprise a polyolefin film layer or a laminate. For example, in certain embodiments, the inner ply comprises nylon or polyethylene. In some embodiments, the inner ply comprises biaxially oriented polypropylene (BOPP). In other embodiments, the inner ply can comprise a material of which merely a component is nylon (e.g., a suitable polyamide) or polypropylene, and can include other materials capable of resisting grease. Some grease-resistant materials can include, for example, metalized films, ethylene vinyl alcohol, polyester, or specialty resins. In some embodiments, the grease-resistant materials provide resistance to and/or prevention of the penetration or absorption of grease, mineral oils, solvents, and/or acids.

In certain embodiments, the inner ply comprises a single layer of polypropylene film. In various embodiments, the polypropylene inner ply can exhibit relatively high grease-resistance, rigidity, translucence, chemical resistance, toughness, fatigue resistance, integral hinge properties, and/or heat resistance. Various forms of polypropylene are possible, and may be selected based on particular needs and cost considerations. For example, the inner ply can comprise homopolymers, block copolymers, or random copolymers.

In certain embodiments, the inner ply comprises a single layer of nylon film. A nylon inner ply can have such properties as relatively high wear and abrasion resistance, relatively high strength, and/or a relatively high modulus (e.g., modulus of elasticity). In other embodiments, the inner ply comprises polyethylene. In certain embodiments, the inner ply includes a multi-layer film or laminate. For example, in some embodiments, the inner ply comprises four or more co-extruded layers or five or more co-extruded layers. A core layer can be positioned at a center of the inner ply in some embodiments, and in other embodiments, can be at an off-centered position.

One or more of a core layer, the films, and/or other layers of a ply can comprise any suitable combination of the materials discussed above with respect to the single-layer inner ply. In some embodiments, the core layer comprises nylon or polypropylene. In other embodiments, the core layer can comprise a metalized film, ethylene vinyl alcohol, polyester, or a specialty resin. In some embodiments, the core layer is substantially grease-proof, is highly puncture resistant, and/or comprises a high modulus.

In various embodiments, one or more of the films and/or additional co-extruded layers of the inner ply can comprise polyethylene, linear low density polyethylene, or metallocine. Other materials are also possible.

In certain embodiments, one or more of the films can be heat-sealable, which can be advantageous for certain uses of a bag 100 or in certain manufacturing procedures used to construct the bag 100. For example, one or more of the films can be configured to advantageously melt and closingly seal at least one of the bag ends 138, 140 in response to the application of heat. As another example, in some embodiments, an inner film that is heat-sealable can advantageously be coupled to a hook and hook closure 150. In certain embodiments, one or more of the films can comprise heat-sealable polyethylene (PE) or oriented polypropylene (OPP). In some embodiments, the core layer can be heat-sealable.

In certain embodiments, the inner ply defines a thickness in a range of between about 0.5 mils and about 7.0 mils. In some embodiments, the thickness is in a range of between about 2.0 mils and about 6.0 mils. Other thickness ranges or gauge values are also possible, and can depend on the use of a bag 100 into which the inner ply is incorporated. For example, in some embodiments, relatively large or heavy bags 100 (e.g., bags having a capacity of about 20 kilograms or more) can benefit from a relatively thicker inner ply. Similarly, in some embodiments, bags used to store relatively sharp or abrasive products 90 can benefit from a relatively thicker inner ply.

In some embodiments, an outer ply is joined to an outer face of the inner ply. Any suitable method for joining the outer ply and the inner ply is contemplated, including any suitable method described above with respect to joining layers of the outer ply. For example, the inner ply and the outer ply can be joined via co-extrusion. In some embodiments, the inner ply and the outer ply are joined via an adhesive. Any other suitable lamination technique is also possible.

In some embodiments, multi-layer material formed in any of the manners described above can be converted into a bag 100. For example, the multi-layer material can comprise an outer ply joined to an inner ply, and the outer and inner plies can be formed into a bag 100. In some embodiments, the outer and inner plies can be substantially coextensive with each other, save for a protruding salvage edge. For example, in some embodiments, the outer ply overlaps the inner ply and defines a surface area that is slightly larger than that of the inner ply such that a portion of the outer ply extends past a peripheral edge of the inner ply to define a salvage edge, as this term is understood in the art. In other embodiments, the inner ply can define a salvage edge. In further embodiments, the inner ply can define a surface area that is larger than that of the outer ply, or the inner ply and the outer ply can define surface areas that are substantially the same.

In certain embodiments, the material is cut or otherwise formed such that it has opposing lateral sides. In some embodiments, the lateral sides are overlapped and joined to each other to define a tubular body 120. The lateral sides can be joined in any suitable manner. For example, in some embodiments, one lateral side is joined to the other lateral side via an adhesive. In other embodiments, the film of the outer ply and the film of the inner ply can comprise heat-sealable materials such that the lateral sides can be joined via a heat seal. In certain embodiments, a portion of the film overlies a portion of the film to define a seam, which can extend along a full longitudinal extent of the tubular body.

Additionally, embodiments of a bag 100 and/or bag closure 150 can include an adhesive including components of rosin ester and ethylene vinyl acetate adhering a portion of at least one of the inner and outer plies of at least one of the opposing bag ends to another portion of the same bag end to define an overlapping seam substantially extending along a transverse extent of at least one of the pair of bag ends. In further embodiments, the adhesive can include a component selected from the group consisting of styrene-isoprene-styrene copolymers, styrene-butadiene-styrene copolymers, ethylene ethyl acrylate copolymers, polyurethane reactive adhesives, tackifiers, waxes, paraffin, antioxidants, plasticizers, plant sterols, terpene resins, polyterpene resins, turpentines, hydrocarbon resins, resin acids, fatty acids, polymerized rosins, and polyamide adhesives.

Within the adhesives industry, hot melts, for example, can have good performance and usage benefits, as understood by those skilled in the art. Hot melt adhesives can be solvent-free adhesives that are characteristically solid at temperatures below 180° F., are low viscosity fluids above 180° F., and rapidly set upon cooling. Hot melt adhesives are used in a variety of manufacturing processes. There are a number of hot melt adhesives in use, with the most common being those used for hot melt pressure sensitive adhesive applications. For example, hot melt adhesives can include ethylene vinyl acetate (EVA) copolymers, which can be compatible with paraffin; styrene-isoprene-styrene (SIS) copolymers; styrene-butadiene-styrene (SBS) copolymers; ethylene ethyl acrylate copolymers (EEA); and polyurethane reactive (PUR).

Generally, these polymers may not exhibit the full range of performance characteristics that can be required for certain end products by themselves. For this reason, for example, a variety of tackifying resins, waxes, antioxidants, plasticizers, viscosity reducers, and other materials can be added to the adhesive formulation to enhance the polymer performance.

In a further embodiment in which one or more bag ends 138, 140 or other bag closures are heat-sealed, a bag end is adapted to be positioned so that opposingly facing first and second portions of the inner ply are compressed between opposingly facing first and second portions of the outer ply to define a compressed lip. The compressed lip, for example, can have a first portion of the second heat-sealable film of the inner ply meltingly bonded with an opposingly facing second portion of the second heat-sealable film of the inner ply along a transverse extent of at least one of the pair of bag ends responsive to heat applied thereto. Application of the heat to the bag end 138, 140 thereby seals the bag end so that a food element 90, when positioned therein, is retained within inner confines of the bag defined by other unsealed portions of the second heat-sealable film positioned between the opposing bag ends 138, 140.

Each of the materials used to construct the bag 100 can have a different range of melting temperatures. For example, in some embodiments, a polyester film of the outer ply has a melting point temperature greater than a heat-sealable film of the inner ply. In one embodiment, the polyester film of the outer ply has a melting temperature in the range of about 300° F. to about 475° F., and may be greater than 425° F. In one embodiment, the heat-sealable film of the inner ply has a melting point temperature in the range of about 220° F. to about 300° F., and may be greater than 300° F. As understood by those skilled in the art, the polyethylene heat-sealable film of the inner ply has a lower melting temperature and therefore melts easier and at lower temperatures than the polyester film of the outer ply. A sufficiently low melting point temperature for the heat-sealable film of the inner ply advantageously allows for the melting and bonding of the second heat-sealable film to closingly seal the bag end 138, 140.

For example, as understood by those skilled in the art, a heat-sealing bag machine performs the function of forming and shaping the multi-layered structure into a bag 100 by accordingly compressing and melting the bag ends 138, 140 to closingly seal the bag ends. The heat-sealing bag machine has an extended heater belt and/or heated jaws that carry out the heat-sealing procedure. The heat can alternatively be applied, for example, by heated rollers, a heated wire/wires, or a heated air zone that adequately melts the heat-sealable film, as understood by those skilled in the art. The extended heater belt and/or heated jaws can mass-produce the heat-sealed products through a continuous high-speed operation, which manufactures a quality product in massive quantities to be delivered to customers. In some applications, for example, the bag manufacturer typically heat-seals one end of each bag 100 and delivers the bag 100 to a customer, and the customer fills the bag 100 with the proper elements 90 and ultimately heat-seals the other end of the bag 100.

To describe heat-sealing processes for certain embodiments more specifically, the polyethylene portion of the heat-sealable film of the inner ply at the bag ends 138, 140 can be heated to a melting point temperature of at least 220° F. to melt the heat-sealable polyethylene film of the bag ends. Alternatively, the temperature could be raised in excess of 300° F., in one embodiment for example, to melt not only portions of the polyethylene heat-sealable films together but also to melt portions of the polyester films together as well, thus advantageously forming an even tighter closed seal at the bag ends 138, 140. For example, the temperature could be raised to between about 375° F. and about 480° F.

Embodiments of methods of assembling, positioning, using, and constructing a reclosable bag 100 are also disclosed herein. The following discussion includes specific references to certain of such embodiments. The discussion is for illustrative purposes only, and should not be construed as limiting. Moreover, any suitable combination of the following disclosure with any portion of the foregoing disclosure is contemplated.

Certain embodiments of reclosable bags 100 and methods herein disclosed can have important benefits and advantages. The combined use of polymeric structures and paper, for example, can combines the advantages of the thickness and bending stiffness of paper with the puncture-resistant and grease-resistant properties of polyester, including in some embodiments the heat-sealable characteristics of films such as polyethylene. Embodiments of a reclosable bag 100 can provide increased barrier protection from grease, endurance, strength, physical integrity, and heat-sealable characteristics not offered with other bags.

The bag 100, significantly, can contain side gussets which may be substantially closed and subsequently opened and re-closed, without needing precise alignment of the hook and hook tracks. Further, embodiments of a reclosable bag 100 may emit a sound when the hook and hook closure is disengaged, enhancing the consumer experience and indicating opening of the bag. The reclosable bag 100 can withstand exposure to fine particles from product 90 and retain the ability to open and reclose.

The bag 100 can advantageously prevent problems customarily associated with greasy products such as pet food, for example, and eliminate the absorption and penetrable effect of the grease component included in such foods. Other applications of the bag 100 may include dry foods, beverages, feed, soil, lawn and garden, and building materials. Furthermore, certain embodiments can offer enhanced strength to allow the bag to carry over twenty-five pounds of pet food with relative ease.

In some embodiments, materials used in constructing a bag can be environmentally friendly, in that the resulting bag is less toxic and increasingly biodegradable. Further, in some embodiments, a bag can advantageously be manufactured on existing equipment, such that investment in new and expensive bag manufacturing equipment is unnecessary.

As discussed above, a variety of bag styles are possible. For example, in various embodiments, the bag can comprise a gusseted pinch-bottom bag configuration, a non-gusseted pinch-bottom bag configuration, a flat bottom, a folded bottom, other various pinch-bottom bag configurations, a non-pinch straight heat sealed bottom, and various SOS (self-opening sack) configurations.

### EXAMPLE 1

An approximately 48 gauge PET layer was reverse printed and laminated to approximately 4.5 mil PE. The approximately 4.5 mil PE and approximately 48 gauge PET were laminated to each other via a solventless adhesive. For material that is used in bags that are configured to contain about 10 lbs or less of product, the thickness of the co-extruded film is about 3.5-5.0 mils. For material that is used in bags that are configured to contain less than about 10-15 lbs of product, the thickness of the co-extruded film is about 5.0-5.5 mils. For material that is used in bags that are configured to contain greater than about 15 lbs of product, the thickness of the co-extruded film is about 5.5-7.0 mils. The multi-layer, laminated material is then converted to bags on upgraded converting equipment.

The hook and hook track has PE ribs on its flanges, which were heat sealed via heat seal bars onto the PE of the inner ply of the laminate when it was a flat web. The hook and hook closure was formed with T-shaped, or mushroom-shaped, appendages. Modified equipment was used to pull the track across the web to be heat sealed. The flat web was formed into a gusseted tube with forming plates and subsequently heat sealed on all four longitudinal edges. Then, the heat seal was applied at the bottom end of the bag, along with miter seals, to close the bag and form the bottom. The bottom of the bag may be left with a bottom seal only, or the bottom can be folded face to back and a hot melt applied, to provide a pinched end. In this Example, the bag was 9 inches wide, had a 4-inch gusset, and 18 inches long (finished length) with a folded bottom. The bag was designed to hold about 6 lbs of pet food.

When the 6 pound SOS bottom or quad seal pet food bag with a hook and hook closure top from Example 1 is filled with 6 pounds of pet food, it can average about 6 consecutive tips before failing. The bag is filled, the hook and hook closure is aligned and pressed closed manually, and the bag is placed on a metal surface. The bag is pushed manually by hand, to tip the bag onto either the front or back walls. The bag is replaced in the upright position and the test is repeated. An unacceptable closure in this tip test would fail after 1 tip. A failure is defined as when pet food breaks through the closure.

Various modifications, changes, and variations apparent to those of skill in the art may be made in the arrangement, operation, and details of the apparatus and methods detailed in the disclosure without departing from the spirit and scope of the disclosure. Thus, it is to be understood that the embodiments described above have been presented by way of example, and not limitation. Any suitable combination of the features described above is contemplated. Moreover, each embodiment recited in the claims that follow is incorporated herein as a separate embodiment.

1. A reclosable bag comprising:
a tube body that defines a front wall, a back wall, a first sidewall that extends between the front and back wall, and a second sidewall that extends between the front and back wall, wherein the tube body has an open top end and a closed bottom end; and
a hook and hook closure element,
wherein the hook and hook closure element is attached around at least a portion of the circumference of the tube body at the top end of the tube body.

2. The bag of claim 1, wherein the hook and hook closure element is heat sealed to the tube body.

3. The bag of claim 1, wherein the first and second sidewalls comprise a gusset.

4. The bag of claim 1, wherein the hook and hook closure element is attached around the full circumference of the tube body.

5. The bag of claim 1, wherein the tube body comprises polypropylene.

6. The bag of claim 1, wherein the thickness of the tube body is between about 30 gauge to about 300 gauge.

7. The bag of claim 1, wherein the thickness of the tube body is between about 36 gauge to about 48 gauge.

8. The bag of claim 1, wherein the thickness of the tube body is between about 0.25 mils and about 1.25 mils.

9. The bag of claim 1, further comprising a seal between the top of the tube body and the hook and hook closure element.

10. The bag of claim 9, wherein the seal is a heat seal.

11. The bag of claim 9, wherein the seal is reclosable.

12. A method of manufacturing a reclosable bag, the method comprising:
forming a tube body that defines a front wall, a back wall, a first sidewall that extends between the front and back wall, and a second sidewall that extends between the front and back wall;
forming an open top end of the tube body;
forming a bottom end of the tube body;
closing the bottom end of the tube body; and
introducing a hook and hook closure element into the top end of the tube body around at least a portion of the circumference of the bag to thereby form a reclosable seal at the top end of the tube body.

13. The method of claim 12, further comprising heat sealing a portion of the hook and hook closure element to the top end of the tube body.

14. The method of claim 12, wherein the first and second sidewalls comprise a gusset.

15. The method of claim 12, wherein the hook and hook closure element is attached around the full circumference of the tube body.

16. The method of claim 12, wherein the tube body comprises polypropylene.

17. The method of claim 12, wherein the thickness of the tube body is between about 30 gauge to about 300 gauge.

18. The method of claim 12, wherein the thickness of the tube body is between about 36 gauge to about 48 gauge.

19. The method of claim 12, wherein the thickness of the tube body is between about 0.25 mils and about 1.25 mils.

20. The method of claim 12, wherein the tube body further comprises a heat seal configured to be sealed after filling the reclosable bag.

21. The method of claim 20, wherein the seal is a heat seal.

22. The method of claim 20, wherein the seal is reclosable.
